(19) United States
(12) Patent Application Publication
(10) Pub. No.: US 2008/0034991 A1
(43) Pub. Date: Feb. 14, 2008

(54) Screen mask, printing device, printing method and manufacturing method of flat display panel

(75) Inventors: Mikio Nakashima, Kunitomi (JP); Naoto Yanagihara, Miyazaki (JP); Masayuki Seto, Miyazaki (JP); Nobuyuki Ushifusa, Yokohama (JP)

Correspondence Address: MCDERMOTT WILL & EMERY LLP, 600 13TH STREET, N.W., WASHINGTON, DC, 20005-3096, US

(73) Assignee: FUJITSU HITACH PLASMA DISPLAY LIMITED

(21) Appl. No.: 11/657,559

(22) Filed: Jan. 25, 2007

(30) Foreign Application Priority Data
Aug. 8, 2006 (JP) JP2006-215346

(51) Int. Cl. B41M 1/12

(52) U.S. Cl. 101/130

(57) ABSTRACT

A technique which enables screen printing on a large printed object is provided. A screen frame of a screen mask has a lower surface (third surface), a screen-mesh holding unit which holds a screen mesh, a surface (fourth surface) which is different from the lower surface, and a screen-frame fixing unit which is fixed in a state in which a first contact region which is a part or the entirety of the surface is in contact with a screen-frame holder of a printing device. The position of the first contact region in a cross section of the screen frame cut from the upper surface toward the lower surface is present above the lower surface.

### CROSS-REFERENCE TO RELATED APPLICATION

The present application claims priority from Japanese Patent Application No. JP 2006-215346 filed on Aug. 8, 2006, the content of which is hereby incorporated by reference into this application.

### TECHNICAL FIELD OF THE INVENTION

The present invention relates to a screen printing technique, and particularly relates to a technique which is effective in application to formation of a pattern onto a flat display panel.

### BACKGROUND OF THE INVENTION

In a configuration described in Japanese Patent Application Laid-Open Publication No. 3-21496 (Patent Document 1), in a screen mask frame which is attached to a screen printer and holds a screen which performs printing on an upper surface of a printed wiring board of which the front end is transported from a side to a predetermined position thereunder, a small screen frame is provided inside a screen-printer-dedicated large screen mask frame, and a stopper which adjusts the position of the small screen mask frame in a lateral direction is provided by the side of the large screen mask frame.

According to this configuration, even when printing is performed on a small printed wiring board by a small screen, the workability and quality of screen printing of the printed wiring board can be improved by positioning it at the center of the small screen mask frame.

### SUMMARY OF THE INVENTION

Screen printing is one kind of stencil printing methods in which a printing agent such as ink is caused to permeate through a stencil silk screen by squeegeeing (extruding the printing agent by a squeegee) so as to transfer a desired pattern onto a printed object, and is utilized in various uses such as circuit wiring formation of IC substrates and pattern formation (electrode formation or fluorescent substance layer formation) of FPDs (Flat Panel Displays).

Particularly, among manufacturing processes of PDP (Plasma Display Panel), screen printing techniques are applied in pattern formation processes such as electrode formation processes and fluorescent substance layer formation processes, and techniques which can perform highly precise printing on a large panel substrate are required in order to increase the display screen size of recent displays or to increase resolution of display image.

The present inventors studied a technique for performing screen printing on FPDs such as PDP, and found out the following problems.

In screen printing, a screen mask fixed to a screen-frame holder of a printing device and a printed object placed on a printing stage are disposed in a predetermined positional relation, and squeegeeing is performed while maintaining the predetermined positional relation, thereby transferring a printing agent to the printed object.

Particularly, when screen printing is to be performed on a large panel substrate, in order to suppress misalignment of the position of a print effective region of the screen mask due to squeegeeing operation, printing is performed while an aluminium screen frame formed around the periphery of the screen mask is fixed to be sandwiched from the upper side and the lower side by using, for example, a screen-frame holder of the printing device.

When the screen frame is deformed by the squeegeeing operation, the predetermined positional relation cannot be maintained, and reduction in printing precision is caused. Therefore, the thickness of the screen-frame holder is made thick to suppress deformation of the screen frame.

Meanwhile, in order to reduce the manufacturing cost of FPDs such as PDP, a method in which, after predetermined patterns are formed in a plurality of panel regions formed on one panel substrate (also referred to as a mother substrate), they are divided into a plurality of individual FPD pieces (generally, called as multi-panel production) is preferred.

By the multi-panel production, panels can be efficiently obtained from one panel substrate. Therefore, the cost of the panel substrate per one panel can be reduced. There is a trend that the planar size of the panel substrate is increased year by year along with increase in the display screen size of displays or the multi-panel production for reducing cost.

However, as described above, the screen mask is fixed so that the screen frame is sandwiched from the upper side and the lower side by the screen-frame holder or the like, and the thickness of the screen-frame holder is thick in order to suppress deformation of the screen frame. Therefore, when the planar dimensions of the panel substrate which is a printed object are increased, the planar dimensions of the screen mask and the screen-frame holder have been required to be larger than the panel substrate.

In a screen mask, a print effective region is, merely the part which contributes to transfer of a printing agent, called an inner mesh in which openings are formed. The plane area of the inner mesh is equal to or less than half of the plane area of the entire screen mask. Therefore, in order to efficiently obtain panels from one panel substrate, a screen mask having a plane area equal to or more than twice the panel substrate has been required to be used.

When the size of the screen mask is increased, not just the cost of the screen mask per se is increased, the size of the printing device has to be bigger. Therefore, it is a factor which increases manufacturing cost.

In addition, when the size of the screen mask is increased, the size of the printing device per se is made bigger. Therefore, not just mechanical precision is reduced, maintaining the predetermined positional relation becomes difficult. Therefore, there is a problem of loss of printing precision.

An object of the invention of present application is to provide a technique which enables screen printing on a large printed object.

Another object of the invention of present application is to provide a technique which can enhance printing precision of screen printing.

Still another object of the invention of present application is to provide a technique which can reduce the manufacturing cost of FPDs.

The above and other objects and novel features of the present invention will be apparent from the description of this specification and the accompanying drawings.

The typical ones of the inventions disclosed in this application will be briefly described as follows.

The present invention is configured so that a screen frame of a screen mask has a lower surface (a third surface), a screen mesh holding member which holds a screen mesh, a fourth surface which is different from the third surface, and a screen frame fixing member which is fixed in a state where a first contact region which is a part or the entirety of the fourth surface is in contact with a screen-frame holder of a printing device; wherein the position of the first contact region in a cross section of the screen frame cut from the upper surface toward the lower surface is present above the third surface.

The effects obtained by typical aspects of the present invention will be briefly described below.

That is, according to the present invention, screen printing can be performed on a printed object having a length on a side which is longer than that of a screen mask.

### BRIEF DESCRIPTIONS OF THE DRAWINGS

FIG. 1 is a plan view showing a state in which a screen frame of a screen mask is fixed to a screen-frame holder of a screen printing device of a first embodiment of the present invention;

FIG. 2 is a plan view showing a rear surface structure of the screen-frame holder to which the screen mask shown in FIG. 1 is fixed;

FIG. 3 is a cross sectional view showing a state in which the device is cut in the direction toward a lower surface along the line A-A shown in FIG. 1;

FIG. 4 is a cross sectional view of a main part of a part of the cross section shown in FIG. 3 is enlarged;

FIG. 5 is a plan view viewed from the upside showing a state after a first printing process is finished in a printing method of the first embodiment of the present invention;

FIG. 6 is a plan view viewed from above showing a state after a second printing process is finished in the printing method of the first embodiment of the present invention;

FIG. 7 is a cross sectional view of a main part taken along the line B-B shown in FIG. 6;

FIG. 8 is a plan view of the panel substrate viewed from above after the second printing process is finished in the printing method of the first embodiment of the present invention;

FIG. 9 is a plan view of the panel substrate viewed from above after the second printing process is finished in a printing method which is a modification example of the first embodiment of the present invention;

FIG. 10 is an enlarged cross sectional view showing a state in which a screen mask which is a modification example of the first embodiment of the present invention is fixed to the screen-frame holder of the printing device of the first embodiment of the present invention;

FIG. 11 is an enlarged cross sectional view showing a state in which a screen mask which is a modification example of the first embodiment of the present invention is fixed to the screen-frame holder of the printing device of the first embodiment of the present invention;

FIG. 12 is an enlarged cross sectional view showing a state in which a screen mask is U-shaped and fixed to a screen-frame holder of a printing device which is a modification example of the first embodiment of the present invention;

FIG. 13 is an enlarged cross sectional view showing a state in which a screen mask is fixed to a screen-frame holder of a printing device of a second embodiment of the present invention by a fixing jig;

FIG. 14 is an enlarged cross sectional view showing a state in which a screen mask is fixed to a screen-frame holder of a printing device which is a modification example of the second embodiment of the present invention by magnetic force;

FIG. 15 is an enlarged cross sectional view showing a state in which a screen mask is fixed to a screen-frame holder of a printing device which is a comparative example of the present invention; and

FIG. 16 is an enlarged cross sectional view showing a state in which the screen mask is fixed to the screen-frame holder of the printing device which is the comparative example of the present invention.

### DESCRIPTIONS OF THE PREFERRED EMBODIMENTS

In embodiments to follow, explanation will be given separately in a plurality of sections or embodiments when needed for the sake of convenience. However, unless otherwise stated, they are not irrelevant to each other, but are in the relation that one of them is a modification example, detail, supplemental explanation and so on of a part or the entirety of the other part.

Moreover, in the following embodiments, when the numbers of elements or the like (including numbers, numerical values, amounts, ranges, etc.) are mentioned, unless, for example, it is otherwise stated and it is obviously limited to particular numbers in principle, they are not limited to the particular numbers, but may be larger or smaller than the particular numbers.

Note that components having the same function are denoted by the same reference symbols throughout the drawings for describing the embodiment, and the repetitive description thereof will be omitted. Hereinafter, embodiments of the present invention will be described in detail with reference to the accompanying drawings.

### First Embodiment

In a first embodiment, regarding a screen printing technique according to the present invention, a process for forming patterns onto a PDP, in which fluorescent paste is applied to the interior of cells divided by dividing walls (dividing walls for separating discharge space into the cells) formed on a panel substrate surface of the PDP, will be described as an example.

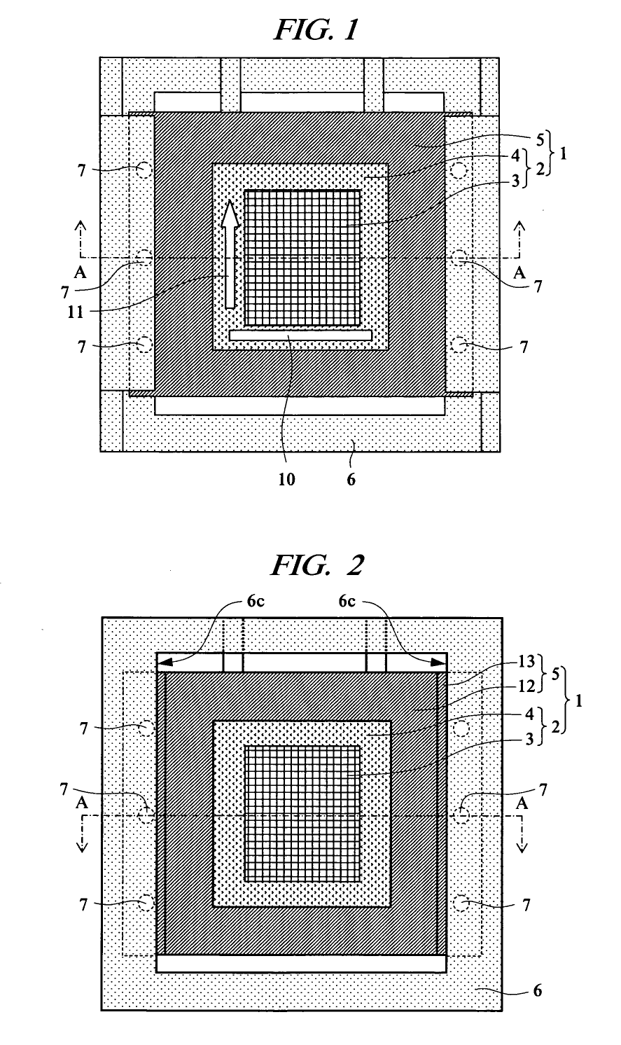

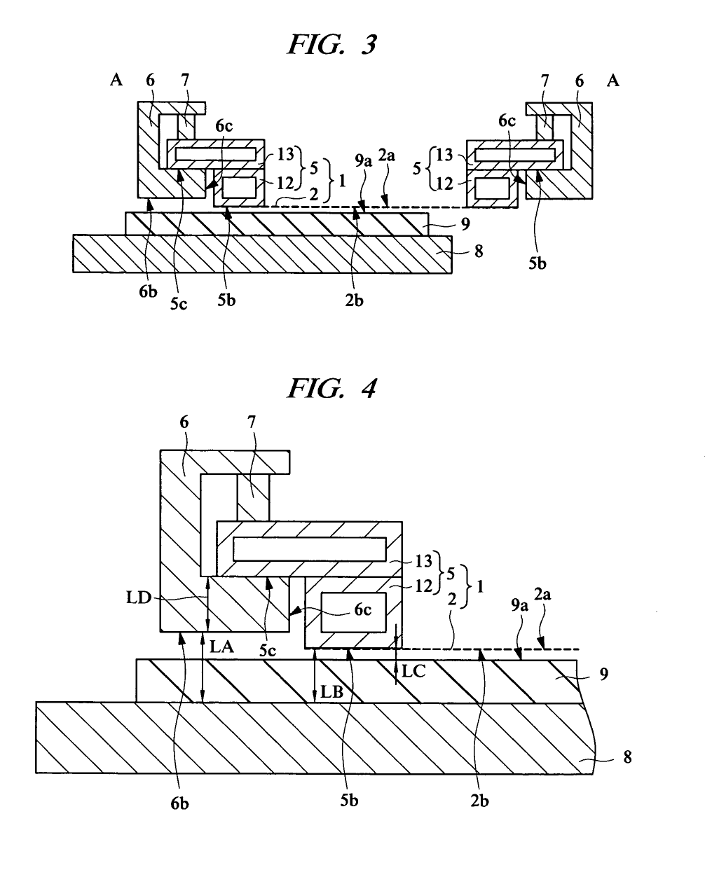

FIG. 1 is a plan view showing a state in which a screen mask is fixed to a screen-frame holder of a screen printing device of the first embodiment of the present invention, FIG. 2 is a plan view showing a state in which the screen-frame holder and the screen mask shown in FIG. 1 are viewed from the rear surface, FIG. 3 is a cross sectional view of a main part taken along the line A-A shown in FIG. 1 and FIG. 2 and showing the positional relation between the panel substrate and a printing stage, and FIG. 4 is a cross sectional view of a main part wherein a part of the cross section shown in FIG. 3 is enlarged.

In FIG. 1 to FIG. 4, the screen mask 1 has an upper main surface (first surface) 2a and a lower main surface (second surface) 2b positioned on the sides opposite to each other, and a screen mesh 2 having a plurality of openings which allows the fluorescent paste to permeate therethrough in the direction from the main surface 2a to the main surface 2b upon printing.

As shown in FIG. 1 and FIG. 2, the screen mesh 2 has an inner mesh 3 in which openings are formed with a desired pattern and an outer mesh 4 which is formed so as to surround the planar perimeter of the inner mesh 3 and causes the inner mesh 3 to be tensed in the outer circumferential directions thereof. The screen mask 1 has a screen frame 5 having four sides. The screen frame 5 holds the screen mesh by fixedly attaching the outer perimeter of the screen mesh 2 by an adhesive or the like in a state in which the main surface 2a of the screen mesh 2 and a lower surface 5b of the screen frame 5 are opposed to each other as shown in FIG. 3 and FIG. 4.

The screen mask 1 is placed on the screen-frame holder 6 of the printing device. Among the four sides of the screen frame 5, two sides opposed to each other are fixed to the screen-frame holder 6 by clamps 7.

In addition, at the main surface 2b side of the screen mask 1, a printing stage 8 which is movable in the direction along the main surface 2b or in the direction intersecting with the main surface 2b is disposed, and a substrate 9 is placed on the stage 8. On an upper main surface 9a of the substrate 9, the cells which separate the discharge space by stripe-like dividing walls (hereinafter, referred to as stripe ribs) or lattice-like dividing walls (hereinafter, referred to as box ribs) are formed.

Moreover, at the main surface 2a side of the screen mask 1, a squeegee 10, which is for example spatula-shaped rubber, is disposed. Upon printing execution, while the squeegee 10 pushes the screen mesh 2 in the direction from the main surface 2a side toward the substrate 9, the squeegee slides in the direction shown by an arrow 11 of FIG. 1 along the main surface 2a, and causes the fluorescent paste, which is a printing agent, to permeate through the openings and be extruded in the direction from the main surface 2a side toward the main surface 2b, thereby filling the cells separated by the stripe ribs or box ribs with the fluorescent paste.

As shown in FIG. 4, the screen frame 5 has the lower surface 5b, a screen-mesh holding unit 12 which holds the screen mesh 2, a surface (fourth surface) 5c which is different from the lower surface 5b of the screen frame 5, and a screen-frame fixing unit 13 which is fixed in a state in which a first contact region which is a part of the surface 5c is in contact with the screen-frame holder 6. The first contact region, which is a part of the surface 5c, is disposed at the side upper than the lower surface 5b (in other words, in the direction from the main surface 2b toward the main surface 2a).

A shortest distance (first distance) LA from a lower surface 6b of the screen-frame holder 6 to the surface of the printing stage 8 is equal to or longer than the difference between a shortest distance (second distance) LB from the lower surface 5b of the screen frame 5 to the surface of the printing stage 8 and a shortest distance (third distance) LC from the lower surface 5b to the upper-side main surface 9a of the substrate 9.

Herein, the distance LC is a clearance distance required for filling merely predetermined positions with the fluorescent paste upon printing execution and is shorter than a distance (thickness of the member supporting the screen frame of the screen-frame holder) LD from the lower surface 6b to the surface 5c of the screen frame 5 shown in FIG. 4.

Before describing effects obtained by features of the screen mask 1 of the first embodiment, a method of two-panel production of a panel substrate will be described as an example of a printing method (hereinafter, described as a step printing method) of the first embodiment.

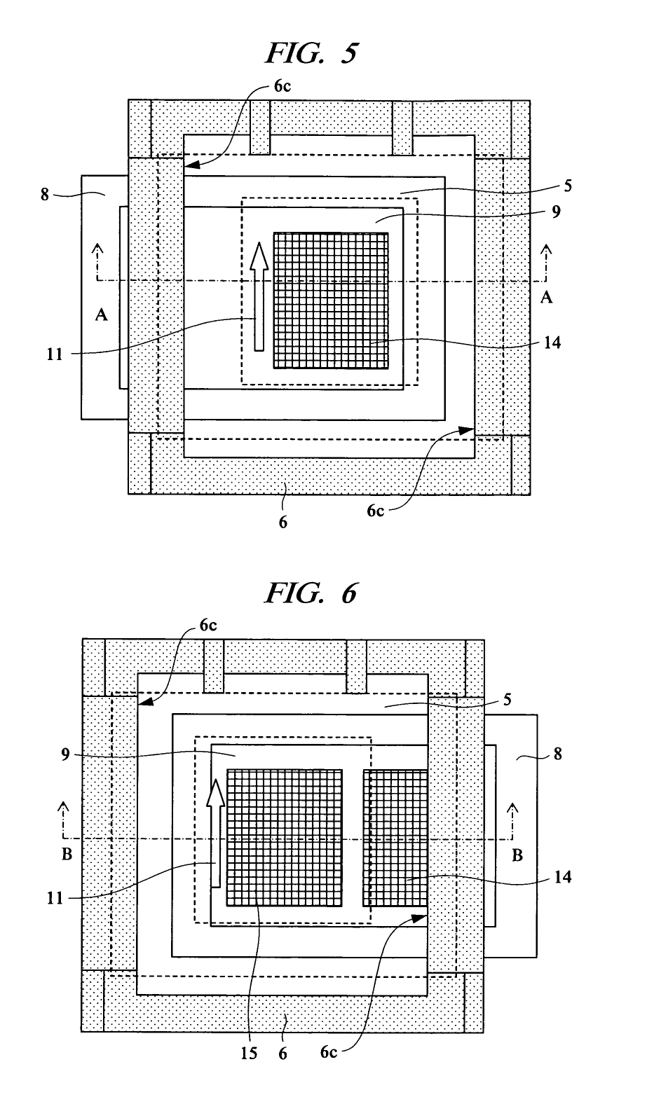

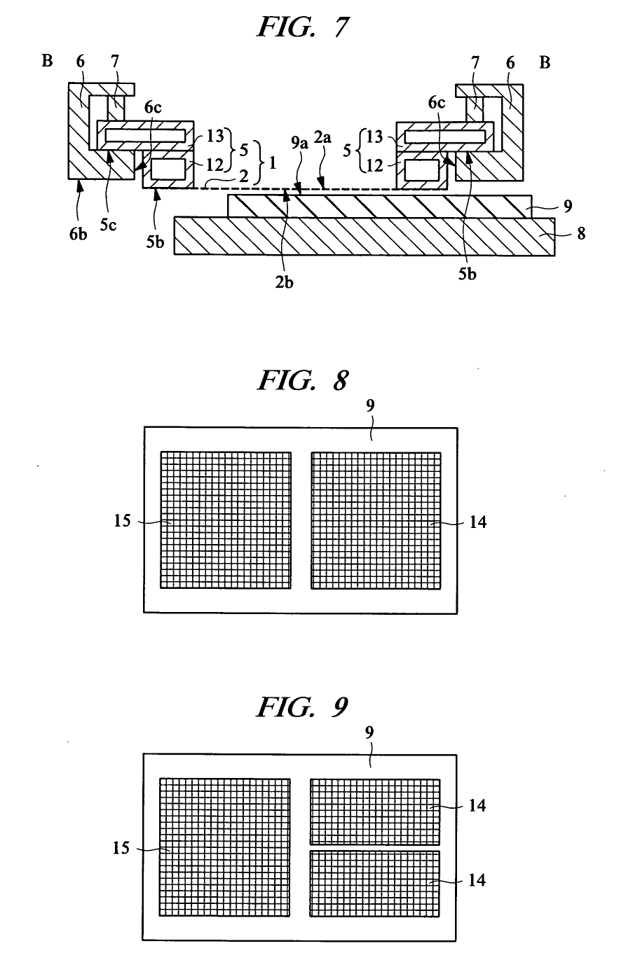

FIG. 5 is a plan view viewed from the upper surface showing a state after a first printing process is finished in the step printing method, FIG. 6 is a plan view viewed from the upper surface showing the state in which a second printing process is finished, FIG. 7 is a cross sectional view of a main part taken along the line B-B shown in FIG. 6, and FIG. 8 is a plan view viewed from the upper surface of the panel substrate after the second printing process is finished.

Note that, in FIG. 5 and FIG. 6, in order to facilitate understanding of features of the step printing method, the squeegee 10 shown in FIG. 1 to FIG. 4 and the screen mesh 2 of the screen mask 1 are not shown, and merely the outlines of the screen frame 5 are shown by dotted lines. The positional relation between the constituent members in the cross section along the line A-A shown in FIG. 5 is same as that shown in FIG. 3 and FIG. 4.

As shown in FIG. 5, the substrate 9 placed on the printing stage 8 and the screen mask 1 (see FIG. 1) fixed to the screen-frame holder 6 are disposed in first positional relation, for example, as shown in FIG. 3 to FIG. 5. The main surface 9a of the substrate 9 is divided into a plurality of panel regions (two regions in the first embodiment). When they are separated into individual pieces in accordance with the division, a plurality of panels are provided.

Means of disposing them in the first positional relation include, for example, a method of operating at least either one of the printing stage 8 and the screen-frame holder 6, wherein either one of them may be operated or both of them may be operated, as long as they can be disposed and maintained in predetermined positional relation, for example of which shown in FIG. 3 to FIG. 6, until the first printing process is finished.

Here, in the first positional relation shown in FIG. 3 to FIG. 5, a planar position of the substrate 9 is located at a position intersecting with an inner side surface 6c of the screen-frame holder 6. When it is thus disposed, screen printing can be performed, for example, on the substrate 9 having long sides longer than one side of the screen mask 1. In other words, screen printing can be performed by using the screen mask 1 having planar dimensions smaller than the substrate 9.

When screen printing is performed by using the screen mask 1 having the planar dimensions smaller than the substrate 9, the size of the printing device is not required to be bigger. Therefore, even when the size of the substrate 9 is increased, reduction in printing precision can be prevented or suppressed.

Moreover, when screen printing is performed by using the screen mask 1 having the planar dimensions smaller than the substrate 9, deformation of, for example, the screen frame 5 in printing processes can be prevented. Therefore, the printing precision can be improved.

Next, as shown in FIG. 3 or FIG. 5, the fluorescent paste (not shown) of a predetermined color is placed on the side of the main surface 2a of the screen mesh 2 of the screen mask 1, the squeegee 10 (see FIG. 1) slides in the direction shown by the arrow 11 in FIG. 5 while pushing the screen mesh 2 in the direction from the main surface 2a side toward the substrate 9 causing the fluorescent paste to permeate through and be extruded from the openings in the direction from the main surface 2a side toward the main surface 2b, and fills the cells divided by the stripe ribs or the box ribs formed in a first printing region 14 of the main surface 9a with the fluorescent paste (in other words, transfer the printing agent to the printed object), thereby forming a predetermined pattern on the main surface 9a of the substrate 9.

The screen mesh 2 is tensed in the directions of the screen frame 5 with the tension within a predetermined range. Therefore, when the squeegee 10 completes the sliding and moves to an upper position, the screen mesh 2 and the substrate 9 are detached from each other, and the first printing process is finished.

Next, as shown in FIG. 6, the substrate 9 placed on the printing stage 8 and the screen mask 1 (see FIG. 1) fixed to the screen-frame holder 6 are disposed in a second positional relation. Means for changing the arrangement from the first positional relation to the second positional relation include various methods as described by using FIG. 3 to FIG. 5. However, any method can be employed as long as they are disposed and maintained in the predetermined positional relation until the second printing process is finished. For example, positioning may be performed after the substrate 9 is once pulled out from the printing stage 8, inversed in a planar direction, and again placed on the printing stage 8.

Herein, also in the second positional relation shown in FIG. 6, a planar position of the substrate 9 is located at a position intersecting with the inner side surface 6c of the screen-frame holder 6. When the planar position of the substrate 9 is thus located at the position intersecting with the inner side surface 6c of the screen-frame holder 6 in the second positional relation, screen printing can be performed on, for example, the substrate 9 having sides longer than one side of the screen mask 1. In other words, screen printing can be performed by using the screen mask 1 having the planar dimensions smaller than the substrate 9.

In the first embodiment, the example in which the planar positions of the substrate 9 are located at the positions intersecting with the inner side surface 6c of the screen-frame holder 6 both in the first positional relation and the second positional relation has been described. However, as long as a planar position of the substrate is located at a position intersecting with the inner side surface 6c of the screen-frame holder 6 in at least one of the first positional relation and the second positional relation, screen printing can be performed on the substrate 9 having the sides longer than one side of the screen mask 1.

Next, as shown in FIG. 6 and FIG. 7, the fluorescent paste (not shown) of a predetermined color is placed on the side of the main surface 2a of the screen mesh 2 of the screen mask 1, the squeegee 10 (see FIG. 1) slides in the direction shown by the arrow 11 in FIG. 6 while pushing the screen mesh 2 in the direction from the main surface 2a side toward the main surface 2b causing the fluorescent paste to permeate and be extruded through the openings in the direction from the main surface 2a side toward the main surface 2b side, thereby filling the cells separated by the stripe ribs or box ribs formed in a second printing region 15 which is not mutually overlapped with the first printing region 14 of the main surface 9a with the fluorescent paste (in other words, the printing agent is transferred to the printed object).

The screen mesh 2 is tensed in the directions of the screen frame 5 by the tension within a predetermined range. Therefore, when the squeegee 10 completes the sliding and moves to an upper position, the screen mesh 2 and the substrate 9 are detached from each other, and the second printing process is finished.

When the substrate 9 is removed from the printing stage after the second printing process is finished, the substrate 9 on which desired patterns are formed on the first printing region 14 and the second printing region 15, which are not overlapped with each other, can be obtained.

Here, for example, when each of the first printing region 14 and the second printing region 15 corresponds to one PDP, two panels can be obtained from the substrate 9 (in other words, two PDPs can be obtained from one substrate 9). Also, when each of the first printing region 14 and the second printing region 15 corresponds to two PDPs, four panels can be obtained from the substrate 9.

In the step printing method of the first embodiment, squeegeeing is individually performed (the printing agent is transferred) for the first printing region and the second printing region which are on the main surface 9a of the one substrate 9 and not overlapped with each other. Therefore, for example, screen printing in which a multi-panel production can be performed for the substrate 9 having one side longer than one side of the screen mask 1 can be performed.

The effective area obtained as a PDP can be increased in one substrate 9 when it is combined with the feature of the step printing method where the planar position of the substrate 9 is located at the position intersecting with the inner side surface 6c of the screen-frame holder 6 at least in either one of the first positional relation or the second positional relation. Therefore, the manufacturing cost of the PDP can be reduced.

The applicable scope of the step printing method of the first embodiment is not necessarily limited to the case in which it is performed for the substrate 9 having one side longer than one side of the screen mask 1. The step printing method of the first embodiment can be applied to the case in which all the sides of the substrate 9 is shorter than one side of the screen mask 1 (in other words, the substrate 9 has a plane area smaller than that of the screen mask).

Specifically, selective printing can be performed multiple times on a plurality of printing regions of the substrate 9 having the plane area smaller than the screen mask which are not overlapped with each other. Also in this case, the effective area obtained as a PDP in one substrate 9 can be increased by applying the step printing method.

The method in which printing is performed twice on the two printing regions of one substrate which are not overlapped with each other has been described as an example of the step printing method in the first embodiment. However, the number of the printing regions and the number of the printing processes are not limited to two. In other words, multiple times of printing processes can be executed for a plurality of printing regions which are not overlapped with each other.

In the above described multiple printing processes, among the predetermined positional relations composed by the substrate 9 which is the printed object and the screen mask 1, a planar position of the substrate 9 is required to be located at a position intersecting with the inner side surface 6c of the screen-frame holder 6 at least in one of the positional relations.

The method in which the same screen mask 1 is used in the first printing process and the second printing process has been described as an example of the step printing method in the first embodiment. However, the screen mask 1 used in the first printing process and the second printing process may be changed.

More specifically, before starting the second printing process after the printing agent is transferred to the printed object by using a first screen mask having openings through which the printing agent permeates formed with a first pattern in the first printing process, it is changed to a second screen mask having openings through which the printing agent permeates formed with a second pattern different from the first pattern, and the second printing process is executed.

When the patterns of the screen masks used in the first printing process and the second printing process are changed in this manner, a plurality of types of PDPs can be obtained from one substrate. FIG. 9 is a plan view in which the panel substrate 9 obtained in the case in which the patterns of the screen masks used in the first printing process and the second printing process are changed is viewed from the upper surface thereof.

As shown in FIG. 9, in the first printing regions 14, cells are filled with the fluorescent paste with the first pattern corresponding to two PDPS. This is the fluorescent paste serving as the printing agent which is caused to permeate and be transferred through the openings formed in the first pattern in the first screen mask. On the other hand, in the second printing region 15, cells are filled with the fluorescent paste with a second pattern corresponding to one PDP.

When a plurality of types of PDPs are obtained from one substrate 9 in this manner, the degree of freedom of production planning can be improved; therefore, production efficiency can be improved, and manufacturing cost of the PDPs can be reduced. Particularly, in application to products produced by production of a wide variety of products in small quantities, further larger cost reduction effects can be obtained.

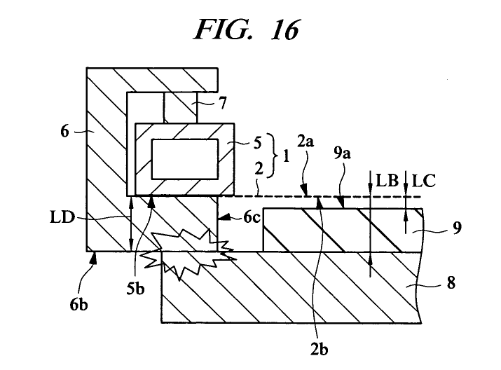

Meanwhile, the screen mask 1 of the first embodiment has features by which effects particularly advantageous in application to the above described step printing method. Comparative examples for explaining the effects obtained by the features that the screen mask of the first embodiment has will be described by using FIG. 15 and FIG. 16.

FIG. 15 is an enlarged cross sectional view of a main part showing a state in which a screen mask, which is a first comparative example, is fixed to a screen-frame holder of a printing device and disposed at a printing execution position, and FIG. 16 is an enlarged cross sectional view of a main part showing a state in which a screen mask, which is a second comparative example, is fixed to a screen-frame holder and disposed at a printing execution position.

FIG. 15 and FIG. 16 are the cross sectional views corresponding to the enlarged cross sectional view of a main part which is described in the first embodiment and shown in FIG. 4, and the components having the same functions as those denoted by the reference symbols shown in FIG. 4 are denoted by the same reference symbols.

In FIG. 15, the screen mask 1 is fixed to the screen-frame holder 6 in the state in which a part of the lower surface 5b by which the screen frame 5 holds the screen mesh 2 is in contact with the screen-frame holder 6. In other words, a point of difference from the screen mask 1 shown in FIG. 4 is that the lower surface 5b and the surface 5c shown in FIG. 4 are a single surface in the screen mask 1 shown in FIG. 15.

When the lower surface 5b and the surface 5c shown in FIG. 4 are caused to be the single surface in this manner, the lower surface 6b of the screen-frame holder 6 is disposed lower than the main surface 2b of the screen mesh. Here, when the planar position of the substrate 9 is located at a position intersecting with the inner side surface 6c of the screen-frame holder 6 as shown in FIG. 15, the distance LC is made longer than the distance LD in order to prevent collision between the substrate 9 and the screen-frame holder 6.

Herein, the distance LD is a part of the screen-frame holder 6 and the thickness of the member supporting the screen frame 5. Therefore, in order to prevent misalignment of the positions of the openings formed in the screen mesh 2 of the screen mask 1 during a printing process, the distance LD is required to have a corresponding thickness.

Meanwhile, the distance LC is a clearance distance for preventing the fluorescent paste from deviating from predetermined cells when the fluorescent paste, which is the printing agent, is extruded from the main surface 2a by the squeegee 10. When the distance LC is longer than the distance LD, printing precision is extremely reduced since a predetermined positional relation between the openings of the screen mesh 2 and the cells of the substrate 9 cannot be maintained.

As shown in FIG. 16, even in the case in which a planar position of the substrate 9 is located at a position not intersecting with the inner side surface 6c of the screen-frame holder 6, when a planar position of the printing stage 8 is located at a position intersecting with the inner side surface 6c of the screen-frame holder 6, the sum of the thickness of the substrate 9 and the distance LC, i.e., the distance LB is longer than the distance LD, the screen-frame holder 6 collides with the printing stage 8.

Regarding the screen mask 1 of the first embodiment, the screen mask 5 is fixed to the screen-frame holder 6 in a state in which the first contact region which is a part of the surface 5c, which is different from the lower surface 5b holding the screen mesh 2, is in contact with the screen-frame holder 6 as shown in FIG. 4, and the screen mask 1 is constituted such that the first contact region is present at the side above the lower surface 5b.

Therefore, the screen mask 1 can be fixed to the screen-frame holder 6 in a state in which the shortest distance LA from the lower surface 6b of the screen-frame holder 6 to the surface of the printing stage 8 is equal to or more than the difference between the distance LB and the distance LC (i.e., thickness of the substrate 9), and the distance LC is shorter than the distance LD.

By fixing the screen mask 1 in a state in which the distance LA is equal to or more than the difference between the distance LB and the distance LC, a planar position of the substrate 9 can be located at a position intersecting with the inner side surface 6c of the screen-frame holder 6. Therefore, the above described step printing method can be carried out.

In addition, by fixing the screen mask 1 in a state in which the distance LC is shorter than the distance LD, the predetermined positional relation between the openings of the screen mesh 2 and the cells of the substrate 9 can be maintained. Therefore, reduction in the printing precision can be suppressed.

Here, regarding the relation between the distance LA and the distance LB, the distance LA is longer than the distance LB. In other words, the mask is preferred to be fixed in a state in which the lower surface 6b of the screen-frame holder 6 is located at a position above the lower main surface 2b of the screen mesh. When it is fixed in this state, for example, even when the above described step printing method is carried out when there is slight distortion in the substrate 9, collision between the main surface 9a of the substrate 9 and the lower surface 6b of the screen-frame holder can be prevented.

Next, other features of the screen mask 1 of the first embodiment will be described with reference to FIG. 4.

In FIG. 4, each of the screen-mesh holding unit 12 and the screen-frame fixing unit 13 is constituted by an independent member having a square-tube-like cross sectional structure, and an upper surface 12a of the screen-mesh holding unit 12 and a lower surface 13b of the screen-frame fixing unit 13 are connected by welding or the like in a state in which they are opposed to and in contact with each other.

The screen frame 5 of the screen mask 1 as shown in FIG. 3 is obtained, for example, by the following manufacturing method. First of all, for example, four square-tube-like rods are formed, for example, by subjecting a screen frame material such as aluminium or the like to pultrusion or extrusion. When these four rods are rectangularly assembled and welded, a member of the quadrilateral screen frame 5 having the screen-mesh holding unit 12 is obtained.

Similarly, two members of the screen frame 5 having the screen-frame fixing unit 13 are formed. The member of the screen frame 5 having the screen-frame fixing unit 13 is extended in a peripheral direction outward more than the outer periphery of the member having the screen-mesh holding unit 12. Therefore, the member is formed to be wider than the member having the screen-mesh holding unit 12.

Next, among the members of the screen frame 5 having the screen-mesh holding unit 12, the members having the screen-frame fixing unit 13 above two opposing sides thereof are welded and fixed, thereby obtaining the screen frame 5 having the cross sectional structure shown in FIG. 3. At this point, the members of the screen frame 5 having the screen-frame fixing unit 13 are caused to extend in the peripheral directions outward more than the outer peripheries of the members having the screen-mesh holding unit 12.

Note that, although the cross section of each member is hollow in the first embodiment, in order to improve the rigidity of the screen frame 5, for example, the structure may have, for example, braces or reinforcement materials which are cross-shaped, X-shaped, etc. in the square tube. These reinforcement materials can be formed at the same time when the square-tube-shaped rods are formed.

In screen printing, since the device is frequently carried, for example, when the printing agent adhered on the screen mask is to be washed, if the weight of the screen mask is increased too much, workability is significantly lowered. Therefore, in many cases, the shape of the screen frame of the screen mask is square tube, and the material is aluminium.

Since the screen mask 1 of the first embodiment may have planar dimensions smaller than the substrate 9, the cross sectional shapes of the screen-mesh holding unit 12 and the screen-frame fixing unit 13 are not limited to the square-tube-like shape. For example, the shape may be a quadrangle not having the inside hollow shown in FIG. 4 at all. When the hollow is not provided inside, the strength of the screen frame 5 can be improved. Therefore, deformation of the screen frame can be suppressed, and the printing precision can be improved.

Also, regarding the material of the screen frame 5, other than aluminium, a stainless steel alloy, a titanium alloy, a carbon FRP, a glass FRP, or a composite material thereof may be used.

Note that the specific weight of the screen frame 5 is increased when the shape or the material of the screen frame 5 is changed. However, by reducing the planar dimensions of the screen mask 1, reduction in the workability of printing processes can be prevented or suppressed.

Each of the screen-mesh holding unit 12 and the screen-frame fixing unit 13 is not limited to be an independent member. More specifically, the screen-mesh holding unit 12 and the screen-frame fixing unit 13 may have an integrated structure as long as the structure has the lower surface 5b which holds the screen mesh and the surface 5c fixed in a state in which it is in contact with the screen-frame holder 6, wherein the surface 5c is disposed above the lower surface 5b.

For example, a quadrangular prism-shaped material is prepared, and one corner portion thereof including the surface serving as the surface 5b of the quadrangular prism is scraped off in the longitudinal direction, thereby producing a column having an outline similar to that of the screen frame 5 shown in FIG. 4. Alternatively, it can be formed by a mold. Next, four columns having similar shapes are produced, assembled to form a quadrilateral shape, and welded, thereby obtaining the screen frame 5 having an integral structure.

By causing the screen-mesh holding unit 12 and the screen-frame fixing unit 13 to have the integrated structure, the strength of the screen frame 5 can be improved compared with the case in which the independent members are assembled. Therefore, printing precision can be improved.

On the other hand, when the screen-mesh holding unit 12 and the screen-frame fixing unit 13 of the screen frame 5 are independent members, although the strength is inferior to the case of the integrated structure, existing screen masks can be utilized since the screen mask 1 of the first embodiment can be obtained by using the screen frame of an existing screen mask as the screen-mesh holding unit 12 and attaching the screen-frame fixing unit 13 thereto as an attachment.

In FIG. 4, the example in which the screen-frame fixing unit 13 having the quadrilateral cross sectional shape is connected to an upper part of the screen-mesh holding unit 12 having the quadrilateral cross sectional shape is described. However, the shapes and the connection relation of the screen-frame fixing unit 13 and the screen-mesh holding unit 12 are not limited thereto.

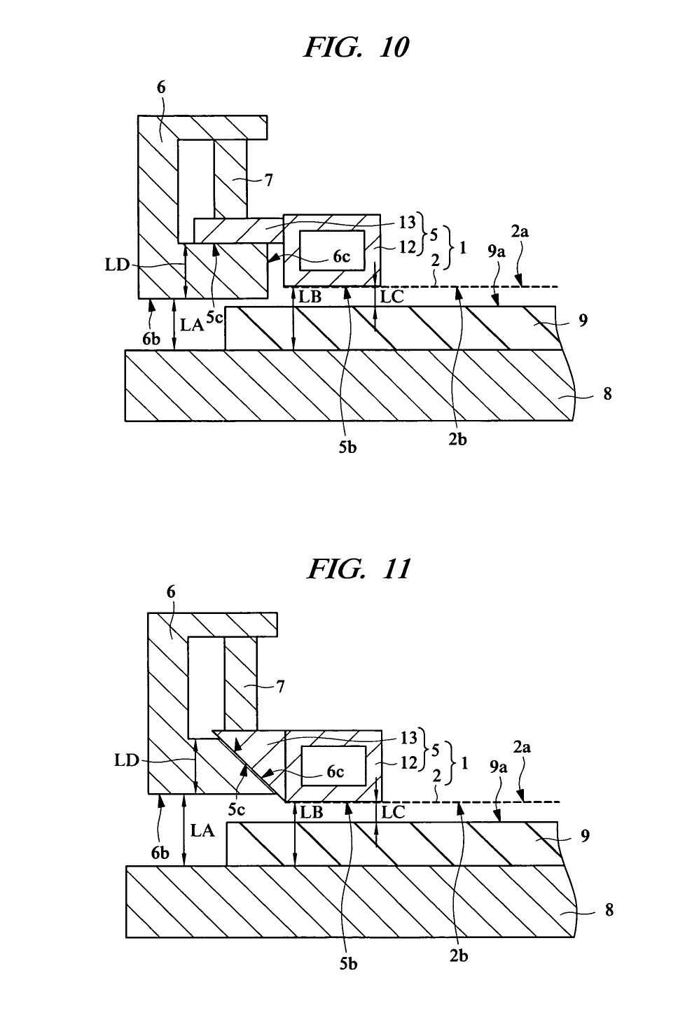

FIG. 10 to FIG. 12 are enlarged cross sectional views of substantial parts, and each of the drawings shows a state in which a screen mask which is a modification example of the first embodiment is fixed to a screen-frame holder and located at a printing execution position.

For example, as shown in FIG. 10, the screen-frame fixing unit 13 may be connected to a side surface (a surface intersecting with the lower surface 5b) of the screen-mesh holding unit 12. Even when they are connected in this manner, the positional relation in which the distance LA≧LB−LC, and the distance LD≧LC can be maintained as shown in FIG. 10 by reducing the thickness of the screen-frame fixing unit 13 or increasing the thickness of the screen-mesh holding unit 12 (length in the direction intersecting with the lower surface 5b).

Note that, in FIG. 10, in order to simplify explanation, the screen-frame fixing unit 13 and the screen-mesh holding unit 12 are shown as independent members. However, in order to improve the connection strength, the screen-frame fixing unit 13 and the screen-mesh holding unit 12 are preferred to have an integrated structure.

In addition, for example, as shown in FIG. 11, the screen-frame fixing unit 13 having three sides in the cross section thereof may be connected to the side surface of the screen-mesh holding unit 12 having four sides in the cross section thereof. In this case, the member of the screen-frame holder 6 which supports the screen frame 5 is processed such that the inner side surface 6c of the screen-frame holder 6 is opposed to the surface 5c of the screen frame 5.

When they are connected in this manner, the area of the first region which is a part of the surface 5c can be increased. Thus, a large frictional resistance force is generated upon squeegeeing, and the printing precision can be improved.

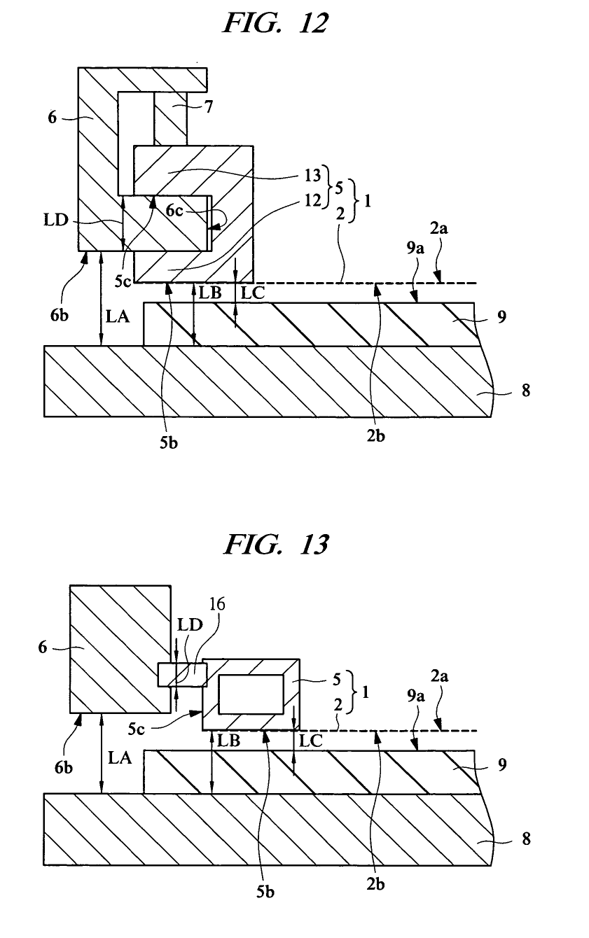

As shown in FIG. 12, the cross sectional shape of the screen frame 5 may be U-shaped, and the member of the screen-frame holder 6, which supports the screen frame 5, may be fixed in a state in which it is interposed between the screen-frame fixing unit 13 and the screen-mesh holding unit 12.

Note that, although the printing device described in the first embodiment is particularly effective in application to the step printing method, the device can be also applied to, for example, the following printing methods. For example, in the case in which printing is to be performed on a large substrate, the screen mask 1 or the printing device described in the first embodiment can be used even when printing is to be selectively performed at one location or when printing is to be performed on the entire surface of the substrate by performing printing once. Moreover, for example, the screen mask 1 or the printing device described in the first embodiment can be used also for a substrate having dimensions smaller than the planar dimensions of the screen mask.

Thus, the screen mask 1 or the printing device described in the first embodiment is not only particularly effective in the step printing method, but also can improve the degree of freedom of production planning since a desired number of printing can be performed on substrates having various dimensions.

### Second Embodiment

In the first embodiment described above, as the means which fixes the screen frame of the screen mask to the screen-frame holder, the method in which a part of the screen frame is clamped by the clamp and the support member of the screen-frame holder was described. In a second embodiment, other fixing means will be described.

FIG. 13 is an enlarged cross sectional view of a main part showing a state in which a screen mask is fixed to a screen-frame holder of a printing device of the second embodiment.

In FIG. 13, the printing device of the second embodiment has a printing stage 8 on which a substrate 9 is placed on, a screen-frame holder 6 having a fixing jig (fixing means) 16 which fixes a screen frame 5 of a screen mask 1 to a predetermined position, and a squeegee (not shown) having a means which extrudes a printing agent in the direction from a main surface 2a of a screen mesh 2 toward a main surface 2b (printing agent extruding means).

The screen mask 1 has the main surface 2a and the main surface 2b positioned at the sides opposite to each other, the screen mesh 2 in which a plurality of openings through which the printing agent permeates through in the direction from the main surface 2a toward the main surface 2b are formed, and the screen frame 5.

The screen mask also has a lower surface (third surface) 5b which is fixedly attached to and retains the outer periphery of the screen mesh 2 by an adhesive or the like, and a surface (fourth surface) 5c which is different from the lower surface 5c that is fixed to the screen-frame holder 6 by the fixing jig 16.

A shortest distance (first distance) LA from the lower surface 6b of the screen-frame holder 6 to the surface of the printing stage 8 is equal to or more than the difference between a shortest distance (second distance) LB from the lower surface 5b of the screen frame 5 to the surface of the printing stage 8 and a shortest distance (third distance) LC from the lower surface 5b of the screen frame 5 to an upper main surface 9a of the substrate 9.

The distance LC is a clearance distance required for filling at predetermined positions with a fluorescent paste upon printing execution, and is shorter than a thickness LD of the fixing jig 16 shown in FIG. 13 (thickness of the member supporting the screen frame of the screen-frame holder).

In the second embodiment, by providing the lower surface 5b which supports the screen mesh 2 and the surface 5c fixed to the screen-frame holder 6 as different surfaces, the relation between the distances LA, LB, LC, and LD can be maintained as the relation in which the distance LA≧LB−LC, and the distance LD≧LC. Therefore, the step printing method described in the first embodiment can be applied.

Examples of the jig fixing means 16 include, for example, screws and pins. In this case, preferably, a groove or an opening for receiving the fixing jig 16 is provided at a predetermined position of the screen frame 5, and the jig is fixed in a state in which the fixing jig 16 is inserted in the groove or the opening.

In another method which is provided as an example, a slit is formed at the predetermined position of the screen frame 5, and the jig is fixed in a state in which a plate-like fixing jig 16 is inserted thereto.

In the method in which the surface 5c of the screen frame 5 is fixed by the fixing jig 16, although attaching/detaching operations are complex compared with the method described in the first embodiment in which a part of the screen frame 5 is clamped by the clamp 7 and the supporting member of the screen-frame holder 6, an effect that existing screen masks can be utilized is obtained.

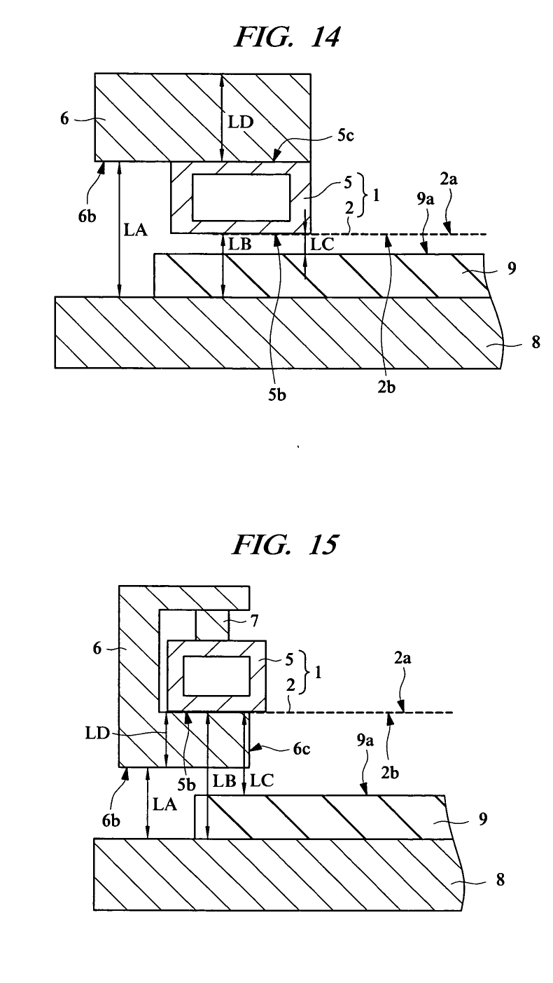

As another fixing means which fixes the screen frame 5 of the screen mask 1 to a predetermined position, a method of fixing it by magnetic force can be used. In this case, as shown in FIG. 14, the areas of the surface 5c of the screen frame 5 and the corresponding lower surface 6b of the screen frame 6 are preferably larger than the area of the surface intersecting with the surface 5c of the screen frame 5. When they are large, the connection strength by the magnetic force can be improved.

In the method which uses the magnetic force as a fixing means, they can be readily attached/detached, for example, by turning on/off an excitation current.

In the foregoing, the invention made by the inventors of the present invention has been concretely described based on the embodiments. However, it is needless to say that the present invention is not limited to the foregoing embodiments and various modifications and alterations can be made within the scope of the present invention.

Although manufacturing processes of PDP was described as examples in the above described first and second embodiments, for example, FED (Field Emission Displays) or LCD (Liquid Crystal Displays) can be also applied.

A manufacturing process of an FED includes a process in which, as well as the manufacturing process of PDP, cells divided by ribs are filled with a fluorescent paste, or a fluorescent layer is formed by forming a fluorescent substance in a plane. Also, the process includes a process of forming wiring by printing. Also, a manufacturing process of an LCD includes a process in which a sealing member (seal material) is formed in the outer periphery of the substrate in order to seal liquid crystal molecules.

It is needless to say that, when the screen printing techniques according to the present invention are applied to these processes, the effect of improving printing precision or the effect which enables obtaining a plurality of surface regions can be obtained.

The present invention can be applied to screen printing, and, in particular, to formation of patterns onto flat panel displays.

What is claimed is:

1. A printing method comprising:
a step of placing a printed object on a printing stage of a printing device;
a step of fixing a screen mask having a first surface and a second surface which are positioned in mutually opposite sides to a screen-frame holder of the printing device;
a step of disposing the printed object and the screen mask so that the positional relation between the printed object and the screen mask is a first positional relation;
a first printing step of extruding a printing agent in a direction from the first surface toward the second surface of the screen mask and transferring the printing agent to a first printing region of the printed object;
a step of disposing the printed object and the screen mask so that the positional relation between the printed object and the screen mask is a second positional relation; and
a second printing step of extruding the printing agent in a direction from the first surface toward the second surface of the screen mask and transferring the printing agent to a second printing region which is not mutually overlapped with the first printing region of the printed object,
wherein, in at least one of the first positional relation and the second positional relation,
a planar position of the printed object is located at a position intersecting with an inner side surface of the screen-frame holder.

2. The printing method according to claim 1,
wherein the screen mask used in the first printing step is a first screen mask in which openings through which the printing agent permeates are formed in a first pattern; and
the screen mask used in the second printing step is a second screen mask in which openings through which the printing agent permeates are formed in a second pattern different from the first pattern.

3. A screen mask comprising:
a screen mesh having a first surface and a second surface positioned in mutually opposite sides and a plurality of openings through which a printing agent permeates in a direction from the first surface toward the second surface; and
a screen frame which has a third surface, and fixedly attaches and holds an outer periphery of the screen mesh in a state in which the first surface of the screen mesh is opposed to the third surface,
wherein the screen frame has
a screen-mesh holding unit which has the third surface and holds the screen mesh, and
a screen-frame fixing unit which has a fourth surface, which is different from the third surface, and is fixed in a state in which a first contact region which is a part or the entirety of the fourth surface is in contact with a screen-frame holder of a printing device; and
a position of the first contact region in a cross section of the screen frame cut from the upper surface toward the lower surface is present above the third surface.

4. The screen mask according to claim 3,
wherein the screen-mesh holding unit and the screen-frame fixing unit have an integrated structure.

5. A printing device comprising:
a printing stage on which a printed object is placed;
a screen-frame holder having a fixing means which fixes a screen frame of a screen mask to a predetermined position; and
a squeegee having a printing agent extruding means,
wherein the screen mask has:
a screen mesh having a first surface and a second surface positioned in mutually opposite sides and a plurality of openings through which a printing agent permeates through in a direction from the first surface toward the second surface; and
the screen frame which has a third surface and fixedly attaches and holds an outer periphery of the screen mesh in a state in which the first surface of the screen mesh is opposed to the third surface,
the screen frame has:
the third surface which holds the screen mesh; and
a fourth surface which is fixed to the screen-frame holder and different from the third surface, and
in a positional relation in a cross section of the screen mask, the printed object, and the printing stage cut from the upper surface to the lower surface,
a first distance which is a shortest distance from a lower surface of the screen-frame holder to a surface of the printing stage is equal to or more than a difference between a second distance which is a shortest distance from the third surface of the screen frame to the surface of the printing stage, and a third distance which is a shortest distance from the third surface of the screen frame to an upper main surface of the printed object, and
the third distance is shorter than the thickness of a member supporting the screen frame of the screen-frame holder.

6. A manufacturing method of a flat display panel comprising:
(a) a step of preparing a substrate having a main surface divided into a plurality of panel regions;
(b) a step of forming a predetermined pattern by transferring a printing agent to the plurality of panel regions by using a screen mask; and
(c) a step of dividing the substrate into a plurality of individual panels;
wherein the step (b) of forming the predetermined pattern on the plurality of panel regions includes
(b1) a step of placing the substrate on a printing stage of a printing device,
(b2) a step of fixing the screen mask having a first surface and a second surface positioned in mutually opposite sides to a screen-frame holder of the printing device,
(b3) a step of disposing the substrate and the screen mask so that the positional relation between the substrate and the screen mask is a first positional relation,
(b4) a first printing step of extruding the printing agent in a direction from the first surface toward the second surface of the screen mask and transferring the printing agent to a first printing region of the substrate,
(b5) a step of disposing the printed object and the screen mask so that the positional relation between the printed object and the screen mask is a second positional relation, and
(b6) a second printing step of extruding the printing agent in a direction from the first surface toward the second surface of the screen mask and transferring the printing agent to a second printing region which is not mutually overlapped with the first printing region of the substrate; and
at least in one of the first positional relation and the second positional relation,
a planar position of the substrate is located at a position intersecting with an inner side surface of the screen-frame holder.
